(19) United States
(12) Patent Application Publication
(10) Pub. No.: US 2019/0064498 A1
(43) Pub. Date: Feb. 28, 2019

(54) D-COLLAR APPARATUS FOR USE WITH A LENS ASSEMBLY OF OPTICAL DEVICE

(71) Applicant: Robert J. McCreight, Boerne, TX (US)

(72) Inventor: Robert J. McCreight, Boerne, TX (US)

(21) Appl. No.: 15/971,758

(22) Filed: May 4, 2018

Related U.S. Application Data
(60) Provisional application No. 62/531,676, filed on Jul. 12, 2017.

(51) Int. Cl. G02B 23/16

(52) U.S. Cl. CPC G02B 23/16

(57) ABSTRACT

A D-collar apparatus for use with a lens assembly of an optical device is provided. The apparatus includes an optical device having a lens assembly. A D-collar includes a circular collar, wherein an axis of the D-collar is orthogonal to the circular collar. Threading is included on an interior portion of the circular collar, and a lip is formed within an internal radial portion of the circular collar and extending between two radial points on the collar. The D-collar is positionable about an O-ring portion of the lens assembly along the axis of the D-collar. The D-collar apparatus can facilitate use of the optical device without an internal lens assembly retaining ring, such that lens assembly of the optical device can be removed without removal of any internal retaining ring.

### CROSS REFERENCE TO RELATED APPLICATION

This application claims benefit of U.S. Provisional Application Ser. No. 62/531,676 filed Jul. 12, 2017, titled “D-Collar Apparatus for use with Objective Lens Assembly of Optical Device,” the entire disclosure of which is incorporated herein by reference.

### FIELD OF THE DISCLOSURE

The present disclosure is generally related to optical devices, and more particularly is related to a D-collar apparatus for use with a lens assembly of an optical device.

### BACKGROUND OF THE DISCLOSURE

Optical devices are commonly used in various environments to enhance the capabilities of the user's vision. In military environments, various optical devices are used to give a soldier enhanced visibility in harsh conditions. For example, devices like the PVS 14 night vision monocular are commonly used in the military to enhance a soldier's visibility in low light conditions. These optical devices are affixed to mounting structures, such as combat helmets, weapons, or other structures that a soldier uses, and during a field operation, a soldier may move the optical device between the various mounting structures. When an optical device is used in a combat environment, it is susceptible to damage from inadvertent contact with environmental structures, such as doors, walls, and other obstacles. Even when not damaged, optical devices must be routinely cleaned and inspected. Inspecting, cleaning, or repairing the optical devices requires disassembly of the entire device, which is time consuming and inefficient, and thus, undesirable.

FIG. 1 is an isometric view illustration of an optical device 10, in accordance with the prior art and FIG. 2 is a cross-sectional view illustration of the optical device 10 of FIG. 1, in accordance with the prior art. FIG. 3 is a partial transparent, partial exploded view illustration of the optical device 10 of FIGS. 1-2, in accordance with the prior art, and FIG. 4 is a partial transparent, partial exploded cross-sectional view illustration of the optical device 10 of FIGS. 1-3, in accordance with the prior art. In particular, FIGS. 1-4 illustrate a PVS-14 night vision monocular typically issued to combat personnel in the United States. The optical device 10 includes a lower monocular housing 12 which contains a battery for powering the optical device 10, an upper monocular housing 14 which generally forms the chassis of the optical device 10, an objective lens assembly 16, an objective lens stop ring 18, and eye piece assembly 20, and an eyepiece locking ring 22.

The PVS-14 and other monocular or goggle optical devices 10 use an objective lens retaining ring 24 to retain the objective lens assembly 16 to the upper monocular housing 14. As shown in FIGS. 2-4, the objective lens retaining ring 24 is a removable spanned nut located interior to the optical device 10 which is threadedly connected to an interior end of the objective lens assembly 16. In order to remove the objective lens assembly 16 for cleaning, repair, or to inspect the interior image tube, the objective lens retaining ring 24 must be removed. As this part is located within the housing 14, the entire optical device 10 must be disassembled in order to access it, which includes removing the rear optics and eyepiece assembly 20, removing the lower housing 12 having the battery module, disconnecting electrical connections between the battery module and housing 12, and removing the image tube of the objective lens assembly 16. Removal of all of these components is required to access the objective lens retaining ring 24 retaining the objective lens assembly 16, which makes repair, inspection, or cleaning of the objective lens assembly 16 a time-consuming and inefficient task.

Another problem with these optical devices 10 concerns the objective lens stop ring 18, which secures the objective lens assembly 16 to the housing 14. As shown in FIGS. 1-4, the objective lens stop ring 18 connects to an end of the housing 14 in a position around the objective lens assembly 16, and in particular, an objective lens O-ring 26. One of the main maintenance issues of the optical device 10 is the wear of the objective lens O-ring 26 and damage to the objective lens assembly 16 through common use and incidental impact. The O-ring 26 is in constant movement due to the translational movement of the objective lens assembly 16 relative to the housing 14 in order to focus at various distances, which leads to O-ring 26 degradation. Additionally, since the objective lens assembly 16 protrudes from the mounting point of the optical device, the user of the optical device 10 accidently—yet commonly makes contact between the objective lens assembly 16 and environmental structures in which the device 10 is used, such as doors, walls and other obstacles, which leads to damage to the objective lens assembly 16 and the O-ring 26. This is especially true when the optical device 10 is used in a helmet-mounted configuration.

Thus, a heretofore unaddressed need exists in the industry to address the aforementioned deficiencies and inadequacies.

### SUMMARY OF THE DISCLOSURE

Embodiments of the present disclosure provide a D-collar apparatus for use with a lens assembly of an optical device. Briefly described, in architecture, one embodiment of the apparatus, among others, can be implemented as follows. The apparatus comprises an optical device having a lens assembly, the lens assembly having an O-ring portion. A D-collar is positionable about the O-ring portion of the lens assembly. The D-collar comprises a circular collar portion having a central axis, a plurality of threading formed on an interior surface of the circular collar portion, and a lip formed along a sidewall of the circular collar portion. The lip is positioned extending across an internal radial portion of the circular collar portion between two radial points on the circular collar portion.

Embodiments of the present disclosure also provide a D-collar apparatus for use with an optical device. Briefly described, in architecture, one embodiment of the apparatus, among others, can be implemented as follows. An optical device has a lens assembly, wherein the lens assembly is movable relative to the optical device along an optical axis thereof A D-collar is positioned exterior of at least a portion of the lens assembly. The D-collar comprises a circular collar portion having a plurality of threading positioned on an internal surface thereof and a lip formed along a sidewall of the circular collar portion. The lip is positioned extending in a tangential direction across an internal radial portion of the circular collar portion, wherein the lip limits a movement of the lens assembly along the optical axis.

Embodiments of the present disclosure also provide a method for limiting movement of a lens assembly of an optical device. In this regard, one embodiment of the method, among others, can be broadly summarized by the following steps: attaching a D-collar around an O-ring portion of the lens assembly, wherein a lip extends tangentially across the D-collar; moving the lens assembly of the optical device along an optical path of the optical device; and stopping a movement of the lens assembly with the lip of the D-collar.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view illustration of an optical device, in accordance with the prior art.

FIG. 2 is a cross-sectional view illustration of the optical device of FIG. 1, in accordance with the prior art.

FIG. 3 is a partial transparent, partial exploded view illustration of the optical device of FIGS. 1-2, in accordance with the prior art.

FIG. 4 is a partial transparent, partial exploded cross-sectional view illustration of the optical device of FIGS. 1-3, in accordance with the prior art.

FIG. 5 is a cross-sectional illustration of an optical device with D-collar, in accordance with a first exemplary embodiment of the present disclosure.

FIG. 6 is an enlarged, cross-sectional illustration of the optical device with D-collar, in accordance with the first exemplary embodiment of the present disclosure.

FIG. 7 is an enlarged, cross-sectional illustration of the optical device with D-collar, in accordance with the first exemplary embodiment of the present disclosure.

FIG. 8 is an isometric illustration of the optical device with D-collar, in accordance with the first exemplary embodiment of the present disclosure.

FIG. 9A is an illustration of the D-collar, in accordance with the first exemplary embodiment of the present disclosure.

FIG. 9B is a cross-sectional illustration of the D-collar, in accordance with the first exemplary embodiment of the present disclosure.

FIG. 10 is a flow chart illustrating a method for limiting movement of an objective lens assembly of an optical device.

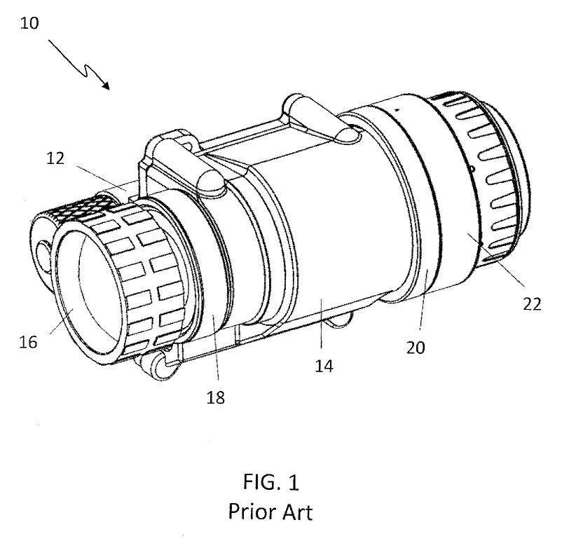

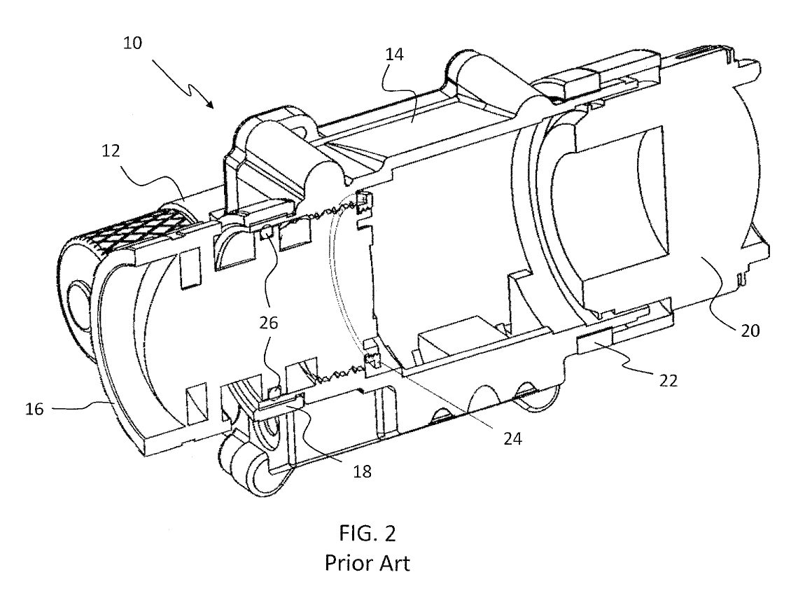

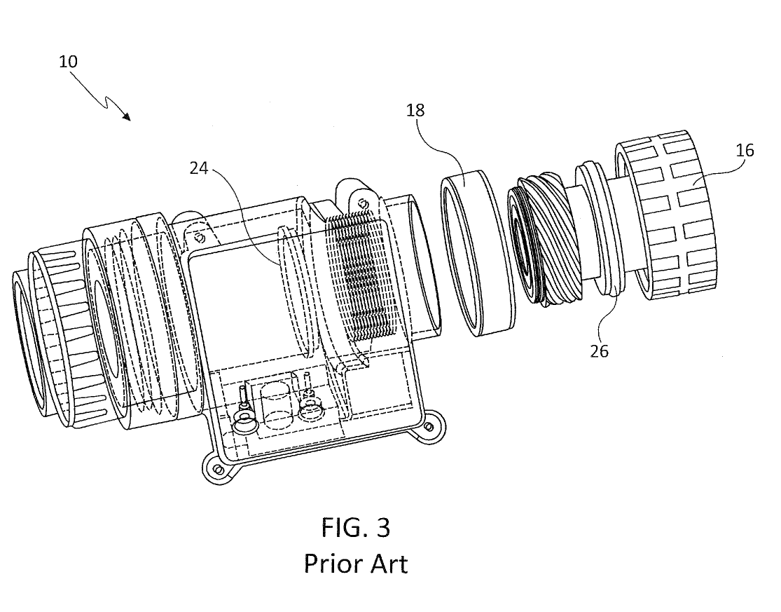

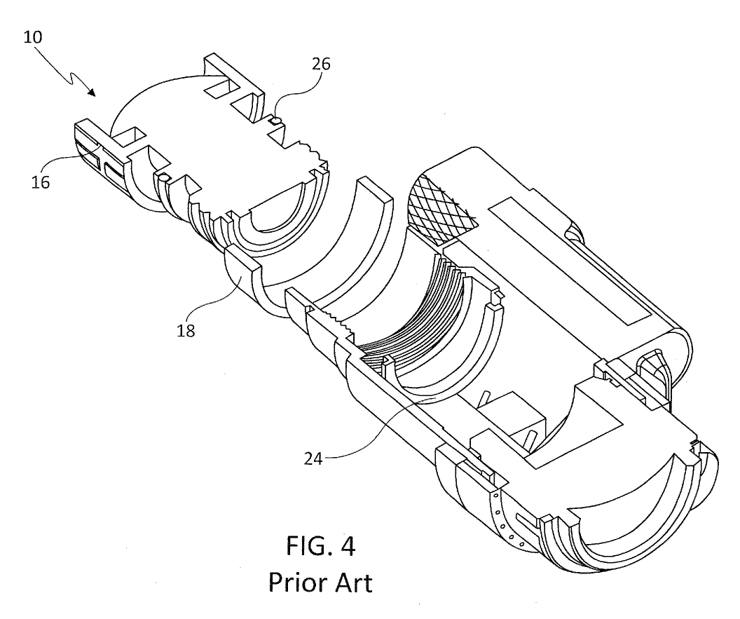

### DETAILED DESCRIPTION

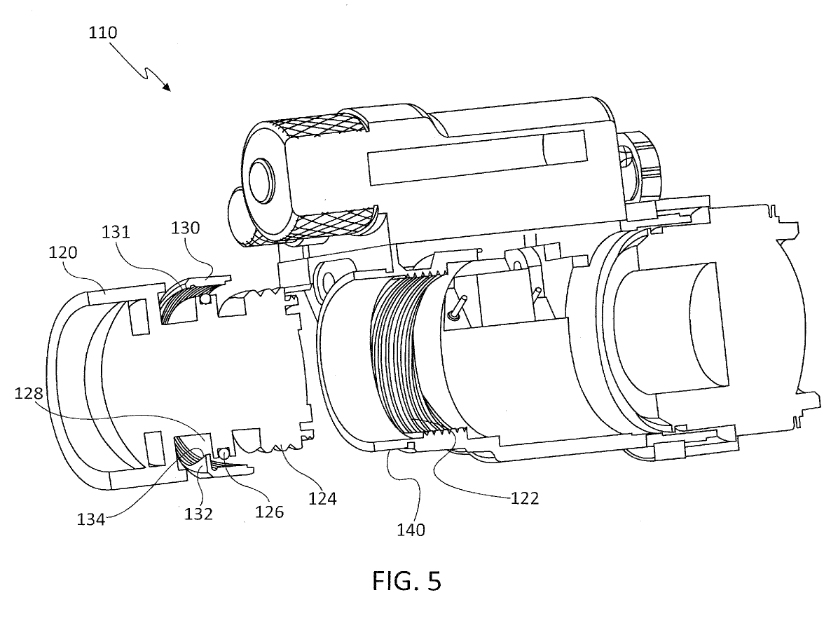

To overcome the aforementioned deficiencies of the PVS 14 optical device and other monocular, goggle or other any other optical systems, a D-collar may be used in place of the conventional lens stop ring. FIG. 5 is a cross-sectional illustration of an optical device 110 with D-collar 130, in accordance with a first exemplary embodiment of the present disclosure. As shown, the optical device 110 includes a lens assembly 120 which is engagable with a housing 122, as is known in the art. The lens assembly 120 includes translational contours (large threading) 124 which engages with cooperating contours in the housing 122 to allow the lens assembly 120 to move within the housing 122 during focusing. An O-ring 126 is positioned about an exterior of the lens assembly 120 and seals against the front portion of the housing 122 during movement of the lens assembly 120. The D-collar 130 is positioned about the O-ring 126 and the lens assembly 120. An outer surface of the D-collar 130 may include ridges to assist a user in installing and removing the D-collar 130 by providing increased gripping area. In one example, the D-collar 130 may have an outer diameter substantially the same as or slightly larger than the outer diameter of the lens assembly 120.

The D-collar 130 may include a circular collar forming the structure of the D-collar 130. The circular collar may generally be substantially circular in shape, although the exterior of the collar may include the ridges described above, and the interior of the collar may include threading 131 on an interior portion of the circular collar, described in further detail below.

An axis of the D-collar 130 may be orthogonal to the circular collar. In other words, the axis may run through a center point of the circular collar, not across the circular portion of the collar. The D-collar 130 may be positionable along its axis during assembly or disassembly on the optical device 110. The axis of the D-collar 130 may align with an optical axis of the optical device 110 such that the axis and the optical axis are collinear. The axes run lengthwise through the center of curvature of the optics in the optical device 110. Thus, the D-collar 130 may be positionable along the optical axis of the optical device 130 during assembly or disassembly.

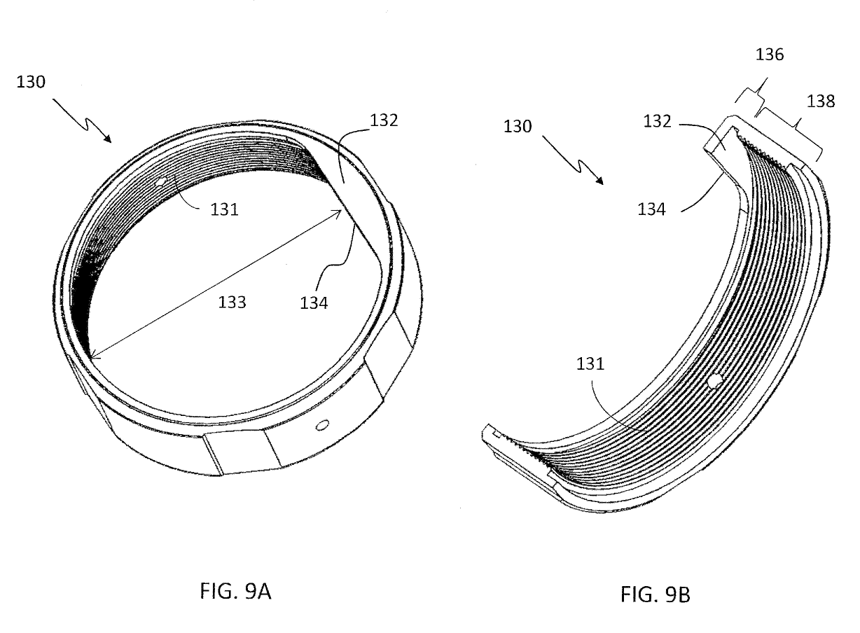

The lens assembly 120 may be used with an objective lens of the optical device 110 or other lenses or structures on the optical device 110. For clarity in disclosure, the description herein is provided relative to use with an objective lens and the lens assembly 120 is referred to as an objective lens assembly 120. As is shown in FIG. 5, the D-collar 130 may replace the standard objective lens stop ring of conventional devices and, in doing so, allow the optical device 110 to function as required without the need for the internal objective lens assembly retaining ring. This is due to the fact that the D-collar 130 utilizes a lip 132 formed on an internal radial portion thereon, i.e., extending in a tangential direction across the D-collar and partially across the circumferential area of the D-collar 130, whereby the lip at least partially occupies the central opening of the D-collar. The internal radial portion of the D-collar 130 is the radial area circumscribed by the circular collar. The lip 132 may be formed within this area. The lip connects to the D-collar along the circular edge of the circular collar, and it extends between two radial points on the circular collar, which increases the structural integrity of the D-collar 130 over that of the conventional device while acting as an interference projection to limit movement of the objective lens assembly 120. Thus, when the objective lens assembly 120 is focused or turned away from the user, the lip 132 of the D-collar 130 will contact the front face 128 of the annular ring on which the O-ring is mounted and stop any further movement of the objective lens assembly 120. Since the lip 132 is integral with the D-collar 130, which is anchored to the lower monocular housing 122 via the monocular housing's threaded external bore 140 and the interior threading 131 (when assembled), the lip 132 will not move when contacted by the objective lens assembly 120. The D-collar 130 as illustrated in full in FIG. 9A, depicts an example of the D-collar structure which may be used with the optical device 110 of FIG. 5.

In one example, the circular collar of the D-ring 130 comprises a sidewall having a lip portion and a non-lip portion. The lip 132 may be formed at or along an outside edge of the sidewall, i.e., not inside the ring shape of the D-collar 130. The threading 131 may be located on the non-lip portion of the sidewall. For instance, the lip 132 may be located across an edge of the sidewall, while the threading 131 is located on substantially the entirety of the interior of the sidewall. The lip portion may be the edge where the lip is located, and the non-lip portion may be the remainder of the sidewall. The lip 132 may be of a thickness sufficient to allow all of the threading 131 to be functional for attachment with the external threaded bore 140.

The lip 132 may be positioned within a motion path of the objective lens assembly 120. The objective lens assembly 120 moves forward and backward through the optical axis of the optical device 110 as it is rotated along the threaded contours 140 of the housing 122. In one example, the placement of the lip 132 may be somewhere within the motion path of one or more elements of the objective lens assembly 120, such that the lip 132 stops motion of the objective lens assembly 120 past the lip 132. For instance, the lip 132 may be positioned to contact the front face 128 of the O-ring portion of the assembly. In another example, the lip 132 may be positioned to contact another face of the assembly. The contact may prevent motion past the lip 132 while allowing the objective lens assembly 120 to remain adjustable.

In one example, the lip 132 may be oriented toward the objective lens housed within the objective lens assembly 120. In this configuration, the lip 132 is located on a side of the D-collar 130 facing the objective lens components. This orientation allows the lip 132 to prevent movement of the objective lens assembly 120 past the lip 132, since during focus the objective lens moves between an initial position (i.e., out of focus) and a secondary position (i.e., in focus) The orientation of the lip 132 may limit the movement of the objective lens assembly 120 such that the assembly 120 moves between the initial position and a position in contact with the lip 132.

It is noted that the lip 132 of the D-collar 130 may have various sizes, but it is preferable for the lip 132 to be sized small enough to allow for positioning of the objective lens assembly 120 through the D-collar 130 during assembly, as will be explained further. Furthermore, the lip 132 may be positioned only on a specific radial portion of the D-collar 130 and not an entirety of the circumference thereof, as is shown in FIG. 9A. Since the lip 132 of the D-collar 130 limits the movement of the objective lens assembly 120 without the need for internal parts, the internal objective lens retaining ring of conventional devices can be omitted. Accordingly, use of the D-collar 130 allows for inspection, removal, maintenance, repair, and cleaning of the objective lens assembly 120 without the need to disassemble all of the other components of the optical device 110.

The size of the lip 132 may be defined by an area of the lip 132 measured across the circumferential area of the D-collar 130. The area of the lip 132 across the circular collar may be small enough to allow the objective lens assembly 120 to pass through the D-collar 130, as discussed above. In one example, the area of the lip 132 may be less than 50% of the area that is circumscribed by the circular collar of the D-collar 130. in another example, the area of the lip 132 may be less than 10% of the area circumscribed by the circular collar.

The O-ring 126 may be positioned about the objective lens assembly 120 at an O-ring portion that includes the annular ring and the front face 128. The O-ring portion of the objective lens assembly 120 may have a diameter, including the O-ring 126, that is smaller than a diameter between the circular collar of the D-collar 130 and the inner edge 134 of the lip 132.

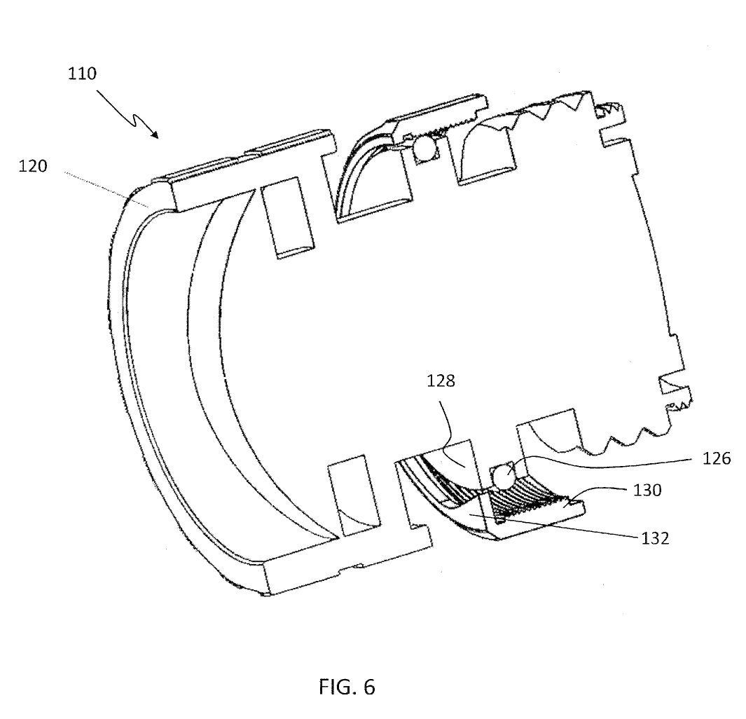

The process for installing the D-collar 130, whether to retrofit an optical device by replacing an existing objective lens stop ring or during initial assembly of the optical device 10, may include the following steps. First, a new monocular housing is required, or disassembly of an existing monocular housing. Next, it may be necessary to remove a small quantity (1 mm) of material from the front/objective bore, which may be achieved using a jig. Once disassembled, the standard objective lens assembly retaining ring (retention spanner) can be discarded. The objective lens assembly 120 is then inserted through the D-collar 130, as is shown in FIG. 6, which is an enlarged, cross-sectional illustration of the optical device 110 with D-collar 130, in accordance with the first exemplary embodiment of the present disclosure.

As shown in FIG. 6, the opening within the D-collar 130 may be sized large enough to allow for only a small gap between the interior diameter of the D-collar 130 and the exterior of the O-ring 126, such that the lip 132 can move past the O-ring 126 and to the front face 128. This gap may be sized correctly due to the fact that the D-collar 130 is not on the housing while the objective lens assembly 120 is being inserted, thus allowing the D-collar 130 to have a temporary non-concentric position with the objective lens assembly 120 which allows enough clearance for the lip 132 to pass by the O-ring 126 without causing damage. In other words, the objective lens assembly 120 can be passed through and over the calculated “d” lip 132 of the D-collar 130 when the circular components are offset before mounting the D-collar 130 onto the monocular housing 122. In this state of assembly, prior to joining the D-collar 130 to the housing 122, there is just enough clearance for the objective lens assembly 120 to pass through the opening of the D-collar 130 in a non-co-radial movement.

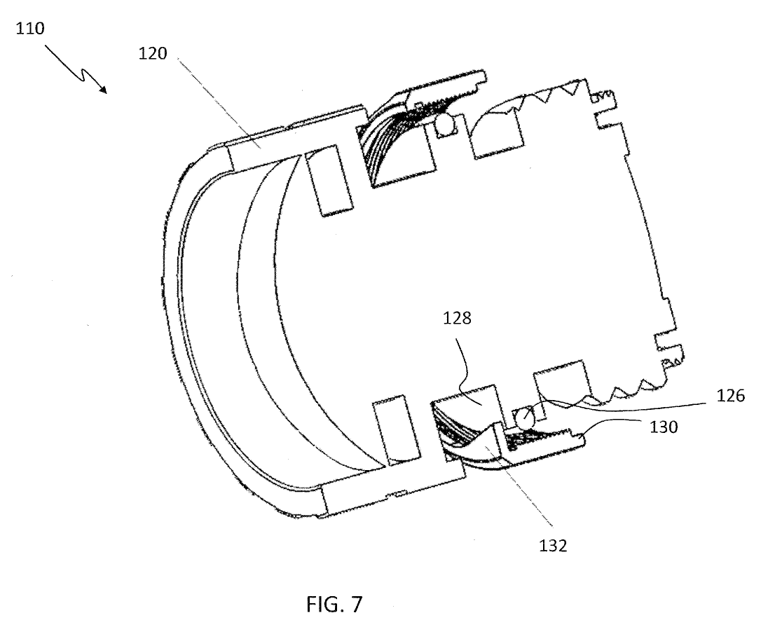

Next, the D-collar 130 may he moved to a substantially concentric position with the objective lens assembly 120, as shown in FIG. 7, which is an enlarged, cross-sectional illustration of the optical device 110 with D-collar, in accordance with the first exemplary embodiment of the present disclosure. FIG. 7 illustrates the proper position post install of the D-collar 130 now in a co-radial positioning and ready to be installed onto the monocular housing 122 threaded bore. This action will then position the objective lens assembly 120 and D-collar 130 in a fixed concentric position, no longer allowing the objective lens assembly 120 to maneuver off-axis and be removed during typical use.

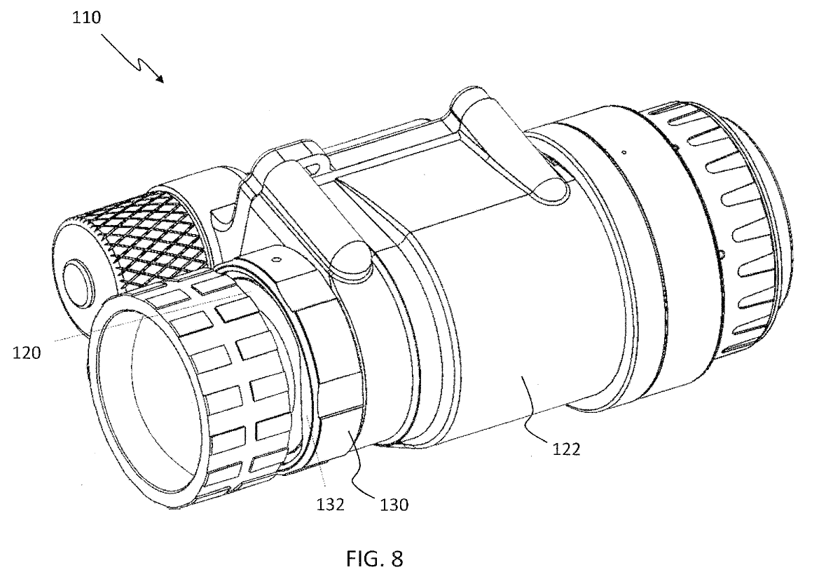

Then, the inner components of the objective lens assembly 120 can be slid into the housing and the D-collar can be affixed to the housing by threading the internal threads of the D-collar 130 to the external threading 140 of the housing. The final position of the D-collar 130 with the objective lens assembly 120 is shown in FIG. 8, which is an isometric illustration of the optical device 110 with D-collar, in accordance with the first exemplary embodiment of the present disclosure.

When removal of the objective lens assembly 120 from the optical device 110 is required, the user may easily be capable of accomplishing the task by loosening and removing the D-collar 130 concurrently as a 2-piece unit connected to the objective lens assembly 120. Reassembly occurs by again pushing the objective lens assembly 120 through the D-collar 130 offset aperture and then threading onto the housing 122 as two separate components, now concentric, which are retained to the housing 122 by threading the D-collar 120 to the housing 122. The D-collar 130 as illustrated in full in FIG. 9A, depicts an example of the D-collar structure which may be used with the optical device 110 of FIGS. 6-8.

FIG. 9A is an illustration of the D-collar 130, in accordance with the first exemplary embodiment of the present disclosure, and FIG. 9B is a cross-sectional illustration of the D-collar 130, in accordance with the first exemplary embodiment of the present disclosure. In particular, the details of the D-collar 130 are shown in FIGS. 9A-9B, including the lip 132 positioned on only a portion of the radial circumference of the D-collar 130. Additionally, the outer contours of the D-collar 130, the inner threading 131, and the various other features of the D-collar 130 are shown.

FIG. 9A shows the diameter 133 between the inner edge 134 of the lip 132 and the circular collar of the D-collar 130 in a position substantially opposite from the inner edge 134, as measured from a central point on an inner edge 134 of the lip 132, along a normal line, and to the circular collar. The diameter 133 is larger than the diameter of the O-ring portion of the objective lens assembly discussed in FIGS. 5-7 to allow for the D-collar 130 to he assembled over the O-ring portion during assembly.

FIG. 9B shows the threading 131 located on the interior portion of the D-collar 130. The threading 131 may be sized and spaced to attach with the outer threading 140 on the optical device housing 122 shown in FIG. 5. The lip 132 is shown spaced slightly from the threading 131 to allow all of the threads to be attached without interference from the lip 132. FIG. 9B also illustrates the lip portion 136 and the non-lip portion 138 of the D-collar 130.

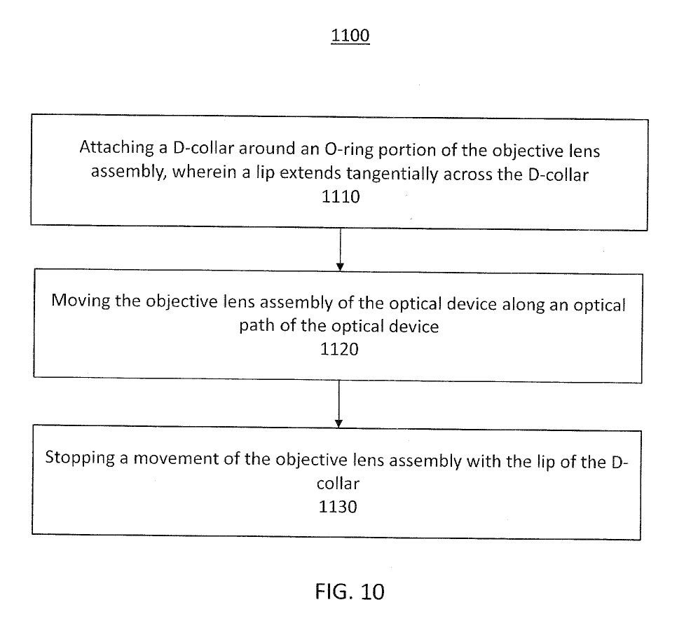

FIG. 10 is a flow chart 1100 illustrating a method for limiting movement of an objective lens assembly of an optical device. It should be noted that any process descriptions or blocks in flow charts should be understood as representing modules, segments, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Step 1110 includes attaching a D-collar around an O-ring portion of the objective lens assembly, wherein a lip extends tangentially across the D-collar. Step 1120 includes moving the objective lens assembly of the optical device along an optical path of the optical device. Step 1130 includes stopping a movement of the objective lens assembly with the lip of the D-collar. The method may further include any of the steps, functions, and structures disclosed with respect to any figure or embodiment of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to he included herein within the scope of this disclosure and the present disclosure and protected by the following claims.

What is claimed is:

1. An apparatus comprising:
an optical device having a lens assembly, the lens assembly having an O-ring portion; and
a D-collar positionable about the O-ring portion of the lens assembly, the D-collar comprising:
a circular collar portion having a central axis;
a plurality of threading formed on an interior surface of the circular collar portion; and
a lip formed along a sidewall of the circular collar portion, the lip extending across an internal radial portion of the circular collar portion between two radial points on the circular collar portion.

2. The apparatus of claim 1, wherein the circular collar portion comprises a lip portion having the lip and a non-lip portion, and wherein the plurality of threading is located on the non-lip portion of the sidewall, and wherein the lip portion and the non-lip portion are located along different axial sections of the D-collar.

3. The apparatus of claim 2, wherein the lip portion is located along an edge of the sidewall.

4. The apparatus of claim 1, wherein a distance between the circular collar portion and an inner edge of the lip is less than a distance of a front wall of the O-ring portion of the lens assembly.

5. The apparatus of claim 1, wherein a diameter of the O-ring portion of the lens assembly is smaller than a distance between an inner edge of the lip and the circular collar portion opposing the inner edge of the lip.

6. The apparatus of claim 1, wherein the O-ring portion of the lens assembly comprises an O-ring, and wherein the D-collar is radially spaced away from the O-ring when assembled on the optical device.

7. The apparatus of claim 1, wherein the lip extends towards an objective lens of the optical device.

8. The apparatus of claim 1, wherein the lip is positioned within a motion path of the lens assembly along a central axis of the lens assembly.

9. An apparatus comprising:
an optical device having a lens assembly, wherein the lens assembly is movable relative to the optical device along an optical axis thereof; and
a D-collar positioned exterior of at least a portion of the lens assembly, the D-collar comprising:
a circular collar portion having a plurality of threading positioned on an internal surface thereof; and
a lip formed along a sidewall of the circular collar portion, the lip extending in a tangential direction across an internal radial portion of the circular collar portion, wherein the lip limits a movement of the lens assembly along the optical axis.

10. The apparatus of claim 9, wherein the circular collar portion comprises a lip portion having the lip and a non-lip portion having the plurality of threading, wherein the lip portion and the non-lip portion are located along different axial sections of the D-collar.

11. The apparatus of claim 10, wherein the lip portion of the sidewall is located along an edge of the sidewall.

12. The apparatus of claim 9, wherein a distance between the circular collar portion and a terminating edge of the lip portion is less than a distance of a front wall of the O-ring portion of the lens assembly.

13. The apparatus of claim 9, wherein the lens assembly comprises an O-ring portion, and wherein a diameter of the O-ring portion is smaller than a distance between an inner edge of the lip and the circular collar portion opposing the inner edge of the lip.

14. The apparatus of claim 13, wherein the O-ring portion of the lens assembly comprises an O-ring, and wherein the D-collar is radially spaced away from the O-ring when assembled on the optical device.

15. The apparatus of claim 9, wherein the lip extends towards an objective lens of the optical device.

16. A method for limiting movement of an lens assembly of an optical device, the method comprising the steps of:
attaching a D-collar around an O-ring portion of the lens assembly, wherein a lip extends tangentially across the D-collar;
moving the lens assembly of the optical device along an optical path of the optical device; and
stopping a movement of the lens assembly with the lip of the D-collar.

17. The method of claim 16, wherein stopping the movement of the lens assembly with the lip of the D-collar further comprises contacting a front face of the O-ring portion of the Lens assembly to an inner surface of the lip.

18. The method of claim 17, wherein a height of the inner surface of the lip is less than a height of the front face of the O-ring portion.

19. The method of claim 16, wherein attaching a D-collar around the O-ring portion of the lens assembly further comprises threadedly connecting an internal threaded portion of the D-collar with an external threaded portion of the O-ring portion.

20. The method of claim 19, wherein the internal threaded portion of the D-collar and the lip are located along different axial sections of the D-collar.
